(19) United States
(12) Patent Application Publication
(10) Pub. No.: US 2017/0115734 A1
(43) Pub. Date: Apr. 27, 2017

(54) TACTILE SENSATION CONTROL SYSTEM AND TACTILE SENSATION CONTROL METHOD

(71) Applicant: MITSUBISHI ELECTRIC CORPORATION, Tokyo (JP)

(72) Inventors: Mitsuo SHIMOTANI, Tokyo (JP); Hidekazu ARITA, Tokyo (JP)

(73) Assignee: MITSUBISHI ELECTRIC CORPORATION, Tokyo (JP)

(21) Appl. No.: 15/319,051

(22) PCT Filed: Sep. 9, 2014
(86) PCT No.: PCT/JP2014/073770

§ 371 Date: Dec. 15, 2016

(51) Int. Cl. G06F 3/01; G06F 3/0488; G06F 3/0484; G06F 3/0354; G06F 3/0485; G06F 3/041; G06F 3/0481

(52) U.S. Cl. CPC G06F 3/016; G06F 3/0416; G06F 3/04883; G06F 3/04817; G06F 3/03547; G06F 3/0485; G06F 3/04845

(57) ABSTRACT

It is an object of the invention to provide a tactile sensation control system and a tactile sensation control method, which allow a user to perform convenient operation with no visual concentration on a display screen. The system includes: a processor to execute a program; and a memory to store the program which, when executed by the processor, performs processes of: detecting an operation by the user to the operation surface, and controlling, when it is detected in the detecting that the user is operating one of an icon operation and a gesture operation, the tactile sensation on the operation surface while the user is operating the one of the icon operation and the gesture operation so that a tactile sensation on an area receiving the one of the icon operation and the gesture operation changes with a lapse of time in accordance with a predetermined tactile sensation change rule.

### TECHNICAL FIELD

The present invention relates to a tactile sensation control system and a tactile sensation control method for control of a tactile sensation of a user operating an operation surface of a touch panel or a touch pad.

### BACKGROUND ART

There is a conventional technique of providing a tactile sensation according to operation to a user operating a display screen of a display device including a touch panel.

For example, there is disclosed a technique of irradiating a finger with ultrasonic waves to provide a finger with a tactile sensation (see, for example, Patent Documents 1 and 2). Another disclosed technique relates to vibrating an appropriate area on a touch panel by means of ultrasonic waves to provide a user with a tactile sensation (see, for example, Non-Patent Document 1). Still another disclosed technique relates to dynamically (physically) raising an appropriate area on a touch panel to provide a tactile sensation (see, for example, Patent Document 3).

### PRIOR ART DOCUMENTS

### Patent Documents

Patent Document 1: Japanese Patent Application Laid-Open No. 2003-29898
Patent Document 2: WO 2012/102026 A
Patent Document 3: Japanese Unexamined Patent Application Publication (Translation of PCT Application) No. 2005-512241

### Non-Patent Document

Non-Patent Document 1: “Trial production of tablet device equipped with touch panel providing tactile sensation”, (online), Feb. 24, 2014, FUJITSU LIMITED, (May 12, 2014), Internet <URL: http://pr.fujitsu.com/jp/news/2014/02/24.html?nw=pr>

### SUMMARY OF INVENTION

### Problem to be Solved by the Invention

Any one of the techniques according to Patent Documents 1 to 3 and Non-Patent Document 1 will allow a user to operate a device depending on tactile sensations with no visual concentration on a display screen. Unfortunately, Patent Documents 1 to 3 and Non-Patent Document 1 fail to disclose specific use and to provide a convenient user interface.

The present invention has been achieved in view of this defect, and an object thereof is to provide a tactile sensation control system and a tactile sensation control method, which allow a user to perform convenient operation with no visual concentration on a display screen.

### Means for Solving the Problem

In order to achieve the object mentioned above, the present invention provides a tactile sensation control system configured to control a tactile sensation of a user operating an operation surface of a touch panel or a touch pad. The system includes: a processor to execute a program; and a memory to store the program which, when executed by the processor, performs processes of: detecting an operation by the user to the operation surface; and controlling, when it is detected in the detecting that the user is operating one of an icon operation and a gesture operation, the tactile sensation on the operation surface while the user is operating the one of the icon operation and the gesture operation so that a tactile sensation on an area receiving the one of the icon operation and the gesture operation changes with a lapse of time in accordance with a predetermined tactile sensation change rule.

The present invention also provides a tactile sensation control method of controlling a tactile sensation of a user operating an operation surface of a touch panel or a touch pad. The method includes: detecting an operation by the user to the operation surface; and controlling, when it is detected that the user is operating one of an icon operation and a gesture operation, the tactile sensation on the operation surface while the user is operating the one of the icon operation and the gesture operation so that a tactile sensation on an area receiving the one of the icon operation and the gesture operation changes with a lapse of time in accordance with a predetermined tactile sensation change rule.

### Effects of the Invention

The present invention provides a tactile sensation control system configured to control a tactile sensation of a user operating an operation surface of a touch panel or a touch pad. The system includes: a processor to execute a program; and a memory to store the program which, when executed by the processor, performs processes of: detecting an operation by the user to the operation surface; and controlling, when it is detected in the detecting that the user is operating one of an icon operation and a gesture operation, the tactile sensation on the operation surface while the user is operating the one of the icon operation and the gesture operation so that a tactile sensation on an area receiving the one of the icon operation and the gesture operation changes with a lapse of time in accordance with a predetermined tactile sensation change rule. The tactile sensation control system thus allows the user to operate comfortably with no visual concentration on a display screen.

The present invention also provides a tactile sensation control method of controlling a tactile sensation of a user operating an operation surface of a touch panel or a touch pad. The method includes: detecting an operation by the user to the operation surface; and controlling, when it is detected that the user is operating one of an icon operation and a gesture operation, the tactile sensation on the operation surface while the user is operating the one of the icon operation and the gesture operation so that a tactile sensation on an area receiving the one of the icon operation and the gesture operation changes with a lapse of time in accordance with a predetermined tactile sensation change rule.

The object, features, aspects, and advantages of the present invention will become more apparent with the following detailed description and the accompanying drawings.

### BRIEF DESCRIPTION OF DRAWINGS

FIG. 1 is a block diagram depicting an exemplary configuration of a tactile sensation control apparatus according to an embodiment 1 of the present invention.

FIG. 2 is an explanatory diagram on tactile sensations according to the embodiment 1 of the present invention.

FIG. 3 is an explanatory graph on tactile sensations according to the embodiment 1 of the present invention.

FIG. 4 is an explanatory graph on tactile sensations according to the embodiment 1 of the present invention.

FIG. 5 is an explanatory graph on tactile sensations according to the embodiment 1 of the present invention.

FIG. 6 is an explanatory diagram on a tactile sensation according to the embodiment 1 of the present invention.

FIG. 7 is a block diagram depicting another exemplary configuration of the tactile sensation control apparatus according to the embodiment 1 of the present invention.

FIG. 8 is a flowchart of exemplary behaviors of the tactile sensation control apparatus according to the embodiment 1 of the present invention.

FIG. 9 is a diagram depicting an exemplary behavior of the tactile sensation control apparatus according to the embodiment 1 of the present invention.

FIG. 10 is a graph indicating an exemplary behavior of the tactile sensation control apparatus according to the embodiment 1 of the present invention.

FIG. 11 is a graph indicating an exemplary behavior of the tactile sensation control apparatus according to the embodiment 1 of the present invention.

FIG. 12 is a diagram depicting an exemplary behavior of the tactile sensation control apparatus according to the embodiment 1 of the present invention.

FIG. 13 is a diagram depicting an exemplary behavior of the tactile sensation control apparatus according to the embodiment 1 of the present invention.

FIG. 14 is a diagram depicting an exemplary behavior of the tactile sensation control apparatus according to the embodiment 1 of the present invention.

FIG. 15 is a diagram depicting an exemplary behavior of the tactile sensation control apparatus according to the embodiment 1 of the present invention.

FIG. 16 is a diagram depicting an exemplary behavior of the tactile sensation control apparatus according to the embodiment 1 of the present invention.

FIG. 17 is a graph indicating an exemplary behavior of the tactile sensation control apparatus according to the embodiment 1 of the present invention.

FIG. 18 is a graph indicating an exemplary behavior of the tactile sensation control apparatus according to the embodiment 1 of the present invention.

FIG. 19 is a block diagram depicting an exemplary configuration of a tactile sensation control apparatus according to an embodiment 2 of the present invention.

FIG. 20 is a flowchart of exemplary behaviors of the tactile sensation control apparatus according to the embodiment 2 of the present invention.

FIG. 21 is a diagram depicting an exemplary behavior of the tactile sensation control apparatus according to the embodiment 2 of the present invention.

FIG. 22 is a diagram depicting an exemplary behavior of the tactile sensation control apparatus according to the embodiment 2 of the present invention.

FIG. 23 is a diagram depicting an exemplary behavior of a tactile sensation control apparatus according to an embodiment 3 of the present invention.

FIG. 24 is a diagram depicting an exemplary behavior of a tactile sensation control apparatus according to an embodiment 4 of the present invention.

FIG. 25 is a diagram depicting an exemplary behavior of the tactile sensation control apparatus according to the embodiment 4 of the present invention.

FIG. 26 is a diagram depicting an exemplary behavior of a tactile sensation control apparatus according to an embodiment 5 of the present invention.

FIG. 27 is a diagram depicting an exemplary behavior of the tactile sensation control apparatus according to the embodiment 5 of the present invention.

FIG. 28 is a diagram depicting an exemplary behavior of the tactile sensation control apparatus according to the embodiment 5 of the present invention.

FIG. 29 is a diagram depicting an exemplary behavior of the tactile sensation control apparatus according to the embodiment 5 of the present invention.

FIG. 30 is a diagram depicting an exemplary behavior of the tactile sensation control apparatus according to the embodiment 5 of the present invention.

FIG. 31 is a diagram depicting an exemplary behavior of the tactile sensation control apparatus according to the embodiment 5 of the present invention.

FIG. 32 is a diagram depicting an exemplary behavior of the tactile sensation control apparatus according to the embodiment 5 of the present invention.

FIG. 33 is a diagram depicting an exemplary behavior of the tactile sensation control apparatus according to the embodiment 5 of the present invention.

FIG. 34 is a diagram depicting an exemplary behavior of the tactile sensation control apparatus according to the embodiment 5 of the present invention.

FIG. 35 is a diagram depicting an exemplary behavior of a tactile sensation control apparatus according to an embodiment 6 of the present invention.

FIG. 36 is a diagram depicting an exemplary behavior of the tactile sensation control apparatus according to the embodiment 6 of the present invention.

FIG. 37 is a diagram depicting an exemplary behavior of the tactile sensation control apparatus according to the embodiment 6 of the present invention.

FIG. 38 is a diagram depicting an exemplary behavior of the tactile sensation control apparatus according to the embodiment 6 of the present invention.

FIG. 39 is a diagram depicting an exemplary behavior of a tactile sensation control apparatus according to an embodiment 7 of the present invention.

FIG. 40 is a diagram depicting an exemplary behavior of the tactile sensation control apparatus according to the embodiment 7 of the present invention.

FIG. 41 is a diagram depicting an exemplary behavior of the tactile sensation control apparatus according to the embodiment 7 of the present invention.

FIG. 42 is a diagram depicting an exemplary behavior of the tactile sensation control apparatus according to the embodiment 7 of the present invention.

FIG. 43 is a diagram depicting an exemplary behavior of the tactile sensation control apparatus according to the embodiment 7 of the present invention.

FIG. 44 is a diagram depicting an exemplary behavior of the tactile sensation control apparatus according to the embodiment 7 of the present invention.

FIG. 45 is a diagram depicting an exemplary behavior of the tactile sensation control apparatus according to the embodiment 7 of the present invention.

FIG. 46 is a diagram depicting an exemplary behavior of the tactile sensation control apparatus according to the embodiment 7 of the present invention.

FIG. 47 is a diagram depicting an exemplary behavior of the tactile sensation control apparatus according to the embodiment 7 of the present invention.

FIG. 48 is a diagram depicting an exemplary behavior of the tactile sensation control apparatus according to the embodiment 7 of the present invention.

FIG. 49 is a block diagram depicting an exemplary configuration of a tactile sensation control system according to an embodiment of the present invention.

FIG. 50 is a block diagram depicting another exemplary configuration of the tactile sensation control system according to the embodiment of the present invention.

### DESCRIPTION OF EMBODIMENTS

Embodiments of the present invention will now be described below with reference to the drawings.

### Embodiment 1

Initially described will be a configuration of a tactile sensation control system according to the embodiment 1 of the present invention. The present embodiment and the embodiments to be described later will refer to a case where a tactile sensation control system is embodied only by a tactile sensation control apparatus.

FIG. 1 is a block diagram depicting an exemplary configuration of a tactile sensation control apparatus 1 according to the present embodiment 1. FIG. 1 depicts minimum necessary constituent elements configuring the tactile sensation control apparatus 1.

As depicted in FIG. 1, the tactile sensation control apparatus 1 includes at least an operation detector 2 and a tactile sensation controller 3.

The operation detector 2 detects a user operation to an operation surface of a touch panel or a touch pad.

The tactile sensation controller 3 controls tactile sensations on the operation surface to cause, with a lapse of time, tactile sensation change in an area receiving user operation detected by the operation detector 2 or tactile sensation change in an area following movement of user operation detected by the operation detector 2.

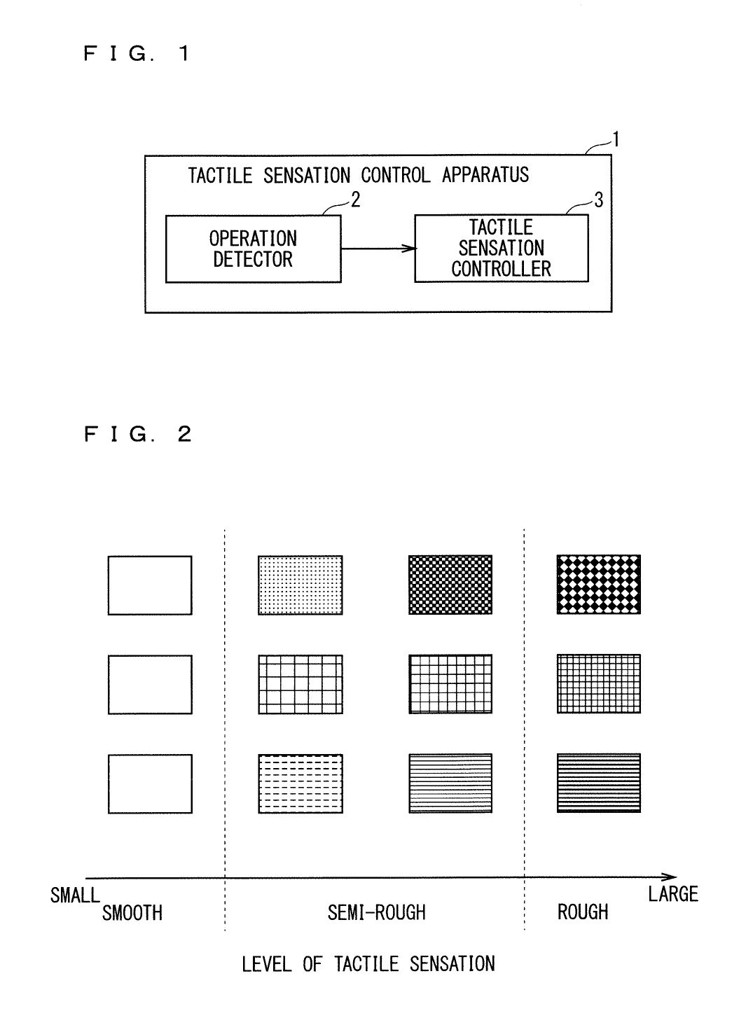

Tactile sensations controlled by the tactile sensation controller 3 will be described below with reference to FIGS. 2 to 6.

FIG. 2 is a diagram depicting three exemplary types of tactile sensations, namely, “smooth”, “semi-rough”, and “rough” tactile sensations.

FIG. 2 has a transverse axis indicating tactile sensation levels. The leftmost column includes “smooth” tactile sensations, the two central columns include “semi-rough” tactile sensations, and the rightmost column includes “rough” tactile sensations. A tactile sensation in each of entire quadrangles is expressed by vibration of ultrasonic waves or the like, of dot or line patterns indicated in black in the quadrangles. In a case where vibration in quadrangles is equal in level, “rough” tactile sensations increase in level gradually from the left to the right in FIG. 2. Specifically, a larger dot indicates a rougher tactile sensation in the first line in FIG. 2, a narrower grid indicates a rougher tactile sensation in the second line, and a solid line rather than a broken line as well as a thicker line indicate a rougher tactile sensation in the third line. Such rough tactile sensation patterns are not limited to those indicated in FIG. 2 and there are an infinite number of combination patterns.

FIG. 2 exemplifies a technique of obtaining different rough tactile sensations with different patterns even at a single vibration level. It is also possible to obtain different rough tactile sensations with different vibration levels even in a single pattern.

A “smooth” tactile sensation is expressed by, for example, no ultrasonic vibration.

A “rough” tactile sensation is expressed by, for example, ultrasonic vibration of a level equal to or more than a predetermined threshold.

A “semi-rough” tactile sensation is expressed by, for example, ultrasonic vibration of a level less than the predetermined threshold.

Rough tactile sensations of different levels are expressed by combination between vibration levels and the rough tactile sensation patterns depicted in FIG. 2.

FIG. 2 illustrates the rough tactile sensation patterns and generation of a static rough tactile sensation without change in vibration level. A moving rough tactile sensation can also be expressed by temporal change in vibration level or by temporal change in rough tactile sensation pattern (i.e. by dynamic change in vibration level or in rough tactile sensation pattern). Change in tactile sensation pattern in an identical area will herein be referred to as fixed tactile sensation change.

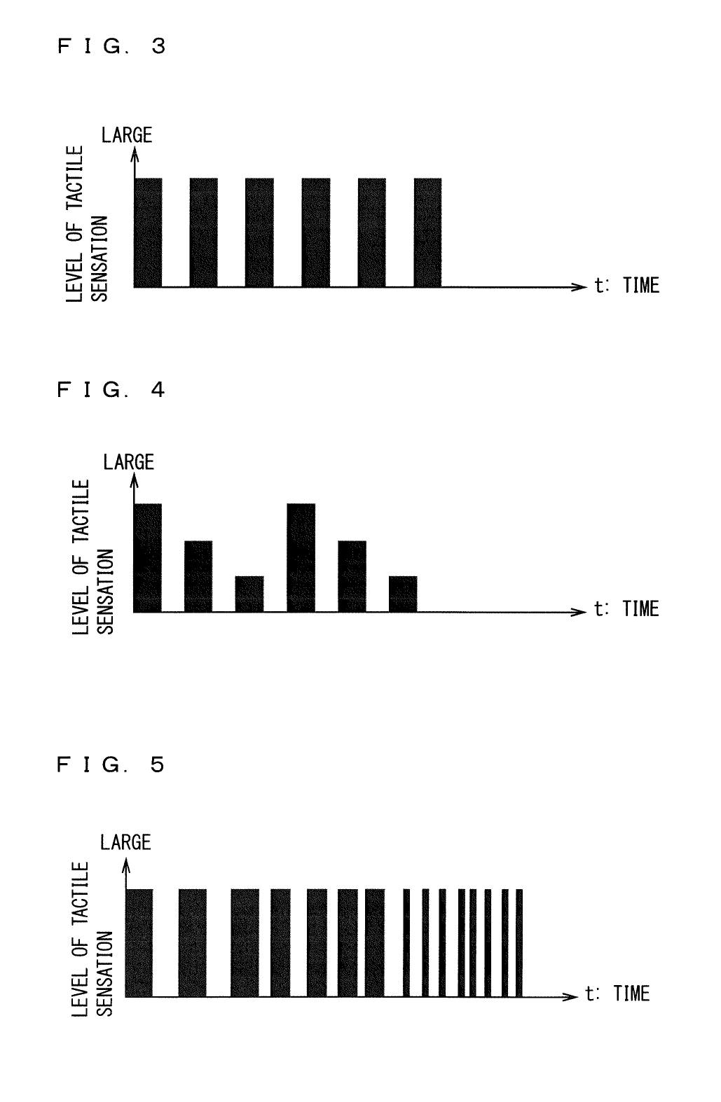

FIGS. 3 to 5 are exemplary graphs of generation of a “moving rough” tactile sensation by temporal change in vibration level. FIGS. 3 to 5 each have a transverse axis indicating time and an ordinate axis indicating tactile sensation levels.

FIG. 3 indicates a case of generating tactile sensations at a constant level at regular intervals. FIG. 4 indicates a case of generating tactile sensations at changed levels at regular intervals. FIG. 5 indicates a case of generating tactile sensations at a constant level at irregular intervals.

Tactile sensation change indicated in FIGS. 3 to 5 allows a user to obtain a tactile sensation as if a “rough” area moves (i.e. a “moving rough” tactile sensation). FIGS. 3 to 5 exemplify alternately switching between “rough” tactile sensations and “smooth” tactile sensations. In addition, “rough” tactile sensations and “semi-rough” tactile sensations are switched alternately, “rough” tactile sensations are switched not discretely but continuously, or continuous change and discrete change are combined freely.

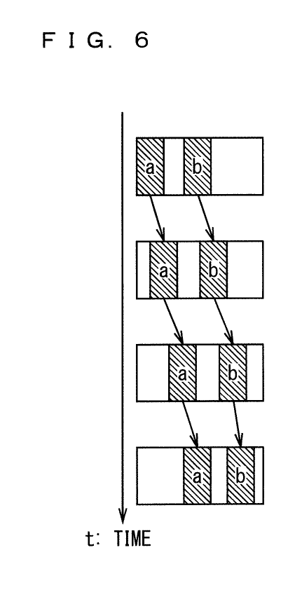

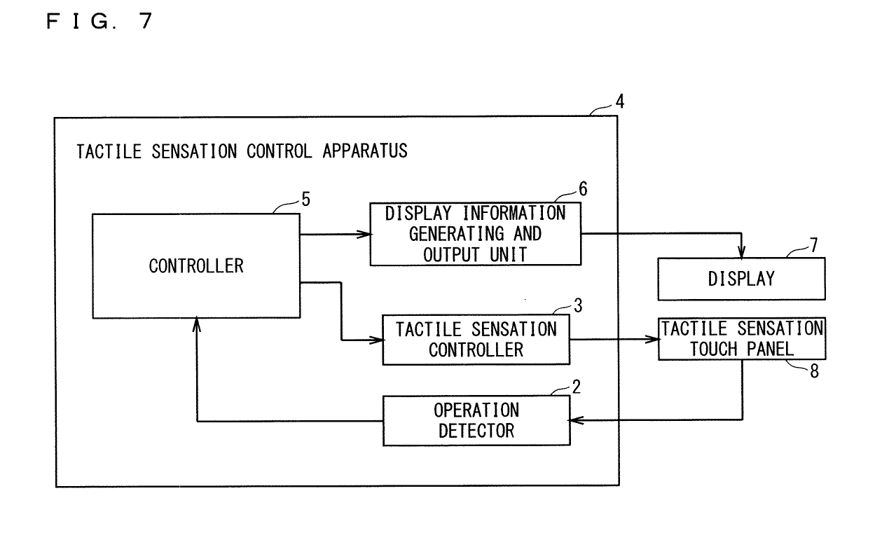

FIG. 6 is a diagram depicting another exemplary case of generating a “moving rough” tactile sensation by temporal change in rough tactile sensation pattern. FIG. 6 has an ordinate axis indicating time. FIG. 6 also depicts areas a and b each having a “rough” tactile sensation, for example.

As depicted in FIG. 6, the areas a and b are positionally changed with a lapse of time. Such movement of the areas a and b having tactile sensations allows a user to obtain a tactile sensation as if a “rough” area moves (i.e. a “moving rough” tactile sensation). Each of the areas a and b can have tactile sensations indicated in any one of FIGS. 3 to 5. Positional change in tactile sensation with a lapse of time will herein be referred to as moving tactile sensation change.

FIG. 6 exemplifies temporal movement of an area having a “rough” tactile sensation and an area having a “smooth” tactile sensation. Alternatively, an area having a “rough” tactile sensation and an area having a “semi-rough” tactile sensation are provided and moved temporally, or an area having a “rough” tactile sensation changed discretely or continuously is provided and moved temporally. Adoption of a “rough” tactile sensation changed continuously in FIGS. 3 to 6 leads to a seamless “moving rough” tactile sensation.

Described next is another configuration of the tactile sensation control apparatus 1 including the operation detector 2 and the tactile sensation controller 3 depicted in FIG. 1.

FIG. 7 is a block diagram depicting an exemplary configuration of a tactile sensation control apparatus 4.

As depicted in FIG. 7, the tactile sensation control apparatus 4 includes the operation detector 2, the tactile sensation controller 3, a controller 5, and a display information generating and output unit 6. The display information generating and output unit 6 is connected to a display 7, and the operation detector 2 and the tactile sensation controller 3 are connected to a tactile sensation touch panel 8.

The controller 5 controls the entire tactile sensation control apparatus 4. FIG. 7 exemplifies a case where the controller 5 controls the tactile sensation controller 3 and the display information generating and output unit 6.

The display information generating and output unit 6 generates display information in accordance with a command from the controller 5. The display information generating and output unit 6 also converts the generated display information to an image signal and transmits the image signal to the display 7.

The tactile sensation controller 3 transmits, to the tactile sensation touch panel 8, tactile sensation control information on control of tactile sensations on the operation surface to cause, with a lapse of time, tactile sensation change in an area receiving user operation detected by the operation detector 2 or tactile sensation change in an area following movement of user operation detected by the operation detector 2.

The operation detector 2 acquires, from the tactile sensation touch panel 8, operation information or information on user operation to the tactile sensation touch panel 8 (i.e. detects user operation to the tactile sensation touch panel 8).

The display 7 displays, on a display screen, the display information transmitted from the display information generating and output unit 6.

The tactile sensation touch panel 8 transmits, to the operation detector 2, operation information or information on user touch operation (information on whether or not touched, a touched position, operation details, and the like). The tactile sensation touch panel 8 has tactile sensation change at an appropriate position on the touch panel (“smooth”, “semi-rough”, “rough”, or “moving rough”) according to the tactile sensation control information transmitted from the tactile sensation controller 3.

The tactile sensation touch panel 8 is provided on the display screen of the display 7, so that a user operates the tactile sensation touch panel 8 with a sensation of direct operation to the display screen. In other words, an area of the display screen of the display 7 can completely agree to an area generating tactile sensations on the tactile sensation touch panel 8. Alternatively, either one of the area of the display screen of the display 7 and the area generating tactile sensations on the tactile sensation touch panel 8 can be larger than the other one. For example, the tactile sensation touch panel 8 is disposed such that the area generating tactile sensations on the tactile sensation touch panel 8 protrudes from the area of the display screen of the display 7, and the protruding area is configured not to display but to receive touch operation.

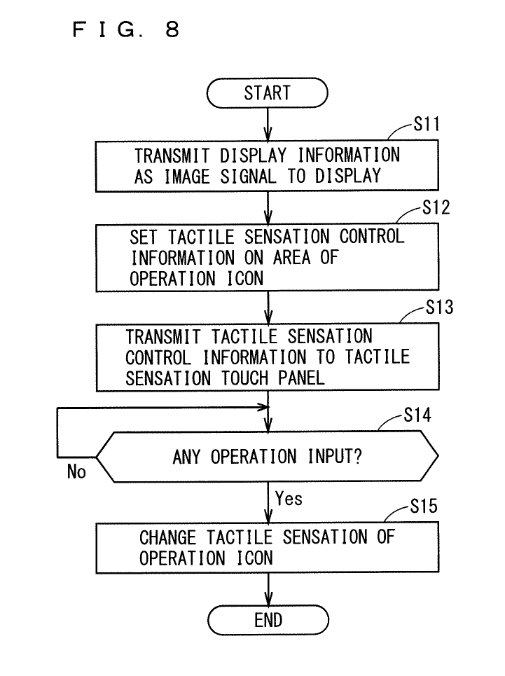

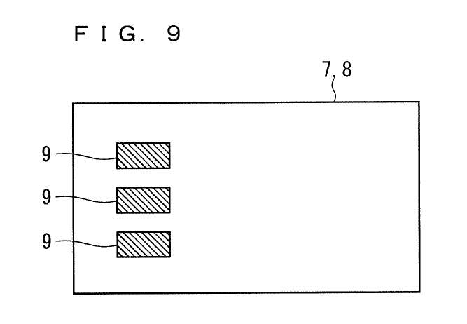

Behaviors of the tactile sensation control apparatus 4 will be described next with reference to FIGS. 8 and 9.

FIG. 8 is a flowchart of exemplary behaviors of the tactile sensation control apparatus 4. FIG. 9 is a diagram depicting an exemplary behavior of the tactile sensation control apparatus 4, and the display 7 displays operation icons 9. The operation icons 9 are provided for user's appropriate operation (icon operation) through touch input to information on the display screen of the display 7.

In step S11, the display information generating and output unit 6 generates display information in accordance with a command from the controller 5, converts the generated display information to an image signal, and transmits the image signal to the display 7. The display 7 displays a screen exemplarily depicted in FIG. 9.

In step S12, the tactile sensation controller 3 sets tactile sensation control information on the areas of the operation icons 9 to “rough” in accordance with the command from the controller 5.

In step S13, the tactile sensation controller 3 transmits, to the tactile sensation touch panel 8, the tactile sensation control information set in step S12. On the tactile sensation touch panel 8, the areas of the operation icons 9 are controlled to have a “rough” tactile sensation in accordance with the tactile sensation control information transmitted from the tactile sensation controller 3.

In step S14, the controller 5 determines whether or not a user touched the tactile sensation touch panel 8 (whether or not the user performed input operation) in accordance with a result of detection by the operation detector 2. The controller 5 stands by until a user touches the tactile sensation touch panel 8, and the process proceeds to step S15 if the user touches the tactile sensation touch panel 8.

In step S15, the tactile sensation controller 3 controls to cause tactile sensation change in the areas of the operation icons 9.

As described above, the area of one of the operation icons 9 has tactile sensation change while a user touches the operation icon 9. Icon operation through touch input according to the present embodiment 1 is assumed to include an operation manner of allowing a user to have a tactile sensation of preliminary icon operation if the user lightly touches the operation surface of the tactile sensation touch panel 8 and receiving icon operation if the user strongly presses the operation surface. A specific example of tactile sensation in the area of the operation icon 9 will be described below.

For example, the area of the operation icon 9 can have tactile sensation change in two stages to “rough” and “smooth” tactile sensations with a lapse of time or in three stages to “rough”, “moving rough”, and “rough” tactile sensations with a lapse of time. Alternatively, the tactile sensations can be appropriately combined and changed in multiple stages.

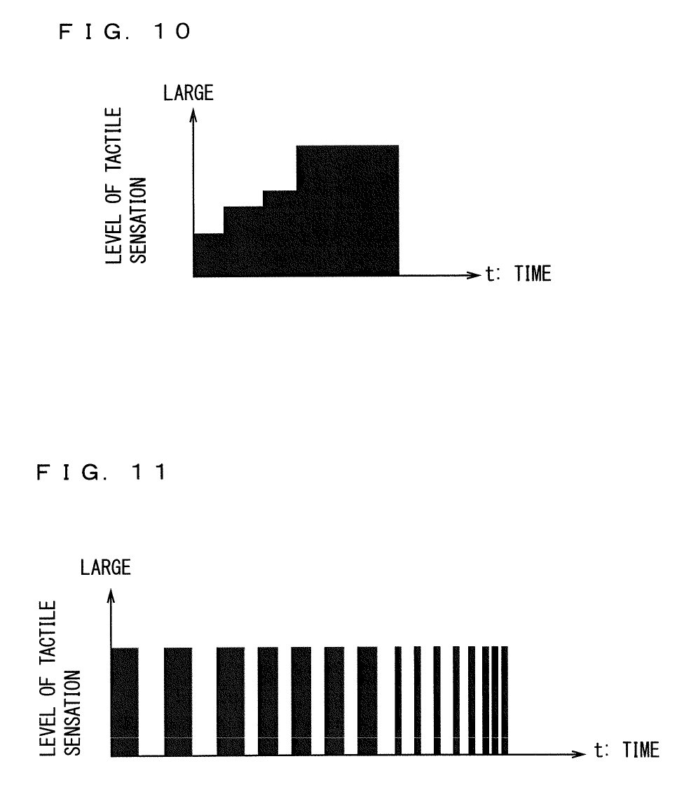

Still alternatively, the tactile sensation of the area of the operation icon 9 can be increased in level stepwise (discontinuously) with a lapse of time as indicated in FIG. 10. The tactile sensation can continuously be increased in level, or can be changed in pattern discontinuously or continuously. As indicated in FIG. 11, the tactile sensations of the area of the operation icon 9 can be kept constant in level and be gradually shortened in interval with a lapse of time. In other words, the area of the operation icon 9 can have tactile sensation change along with interval change (or periodically). As depicted in FIG. 12, the tactile sensation of the area of the operation icon 9 can be changed in level only in an upper (alternatively, a lower, right, or left) portion. In other words, a plurality of portions in the area of the operation icon 9 can be different in tactile sensation change. As depicted in FIG. 6, the area of the operation icon 9 can have a “moving rough” tactile sensation. Such a behavior allows a user to easily find operation to the operation icon 9. Particularly in the case of FIG. 12, the area of the operation icon 9 has partial change in tactile sensation to achieve energy saving. In FIG. 12, the level of the tactile sensation can change, instead of in the two stages, in multiple stages or continuously like a sine wave. As described above, the tactile sensation controller 3 controls, in accordance with a predetermined tactile sensation change rule, a tactile sensation to cause fixed tactile sensation change having tactile sensation change in level or in pattern in an identical area, or moving tactile sensation change having positional change in tactile sensation with a lapse of time.

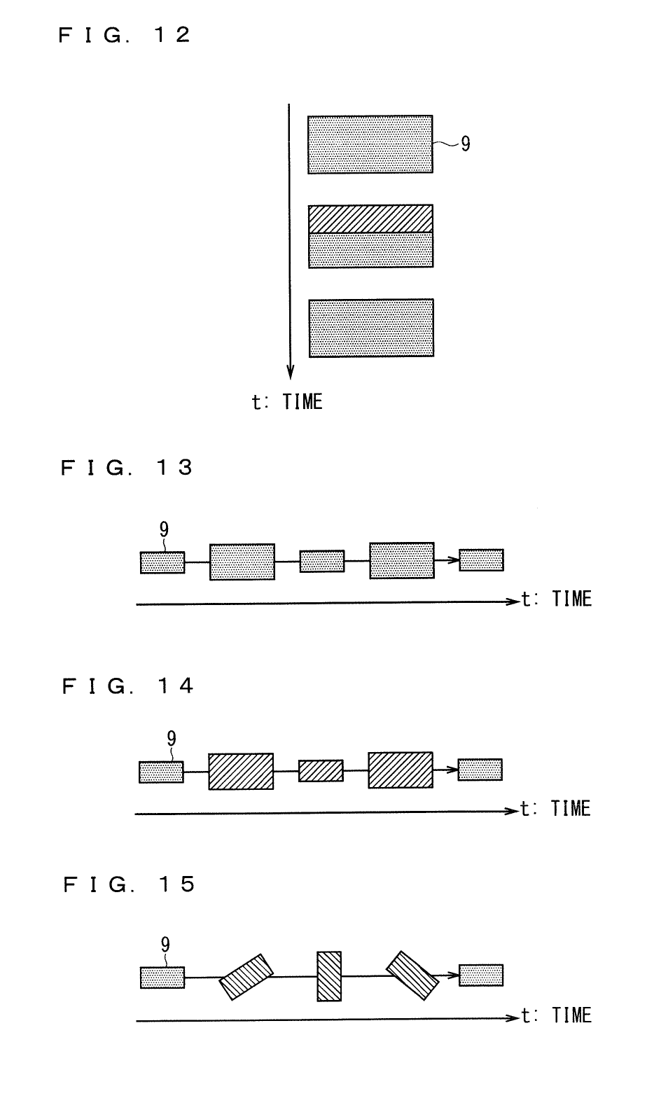

As depicted in FIG. 13, the tactile sensation of the area of the operation icon 9 can be kept constant in level and the portion providing the tactile sensation in the area of the operation icon 9 can be changed in shape with a lapse of time. As depicted in FIG. 14, the area of the operation icon 9 can have tactile sensation change and the portion providing the tactile sensation in the area of the operation icon 9 can be changed in shape with a lapse of time. As depicted in FIG. 15, the area of the operation icon 9 can have tactile sensation change and the portion providing the tactile sensations in the area of the operation icon 9 can be turned with a lapse of time. Such a behavior allows a user to easily find operation to the operation icon 9. In FIGS. 13 to 15, the operation icon 9 displayed on the display 7 can be changed in shape in accordance with change in shape of the portion providing the tactile sensation in the area of the operation icon 9. The area of the operation icon 9 can have tactile sensation change in any one of the above manners.

In a case where the operation icon 9 is configured to receive mode switching operation, the area of the operation icon 9 can have tactile sensation change according to the mode switching. In a case of switching between modes A and B, tactile sensation in the area of the operation icon 9 for switching from the mode A to the mode B can be made different from tactile sensation change in the area of the operation icon 9 for switching from the mode B to the mode A. This allows a user to easily find switching to which mode. Examples of an icon configured to receive mode switching operation include an icon for switching between north-up map display and heading-up map display in a case where the display 7 displays a map. The area of the operation icon 9 can have tactile sensation change in any one of the above manners. Such mode switching is not limited to switching of display contents or a display manner, and examples of the mode switching include change in type of received operation and change in behavior mode of a device connected to the system including the tactile sensation control apparatus 4.

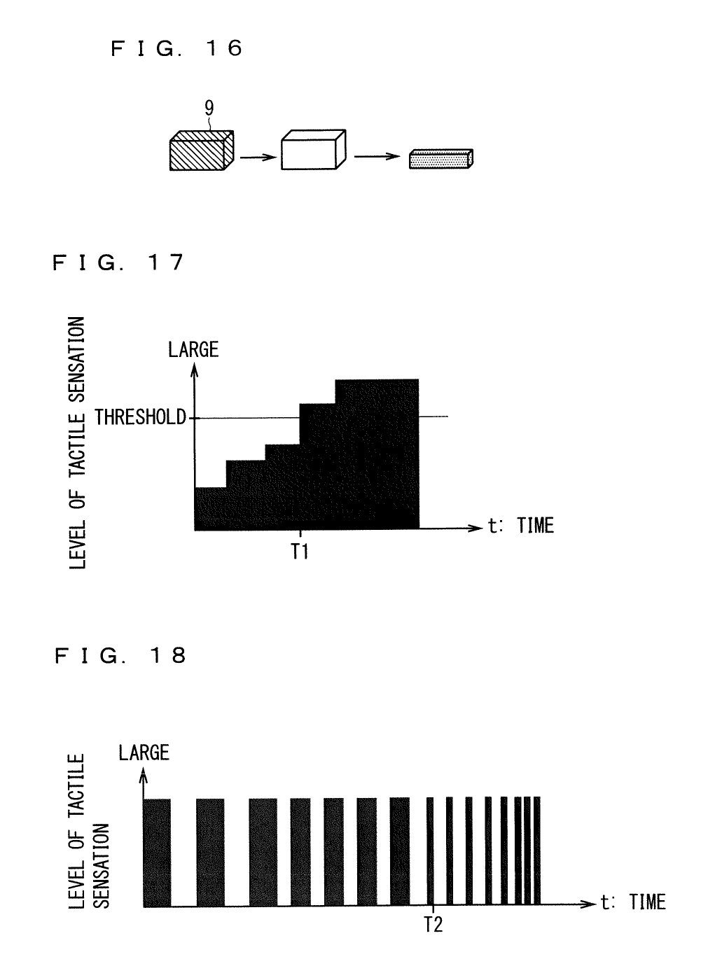

As depicted in FIG. 16, the area of the operation icon 9 can have tactile sensation change and the operation icon 9 displayed on the display 7 can be changed in display mode. Display modes of the operation icon 9 relate to a shape and a color of the operation icon 9. In a case where the displayed operation icon 9 has a toggle switch shape, the operation icon 9 can be changed in shape to indicate operation to the toggle switch and the area of the operation icon 9 can have tactile sensation change. The area of the operation icon 9 can have tactile sensation change in any one of the above manners in this case. This allows a user to easily find operation to the operation icon 9.

Described next is how to determine whether or not a user operates the tactile sensation touch panel 8.

In a case where the tactile sensation of the area of the operation icon 9 is increased in level stepwise (or continuously) with a lapse of time as exemplified in FIG. 17, determination can be made such that a user operates the tactile sensation touch panel 8 (operation is valid) if the level of the tactile sensation exceeds a predetermined threshold (if time t=T1). This achieves prevention of erroneous operation and reliable receipt of operation intended by a user.

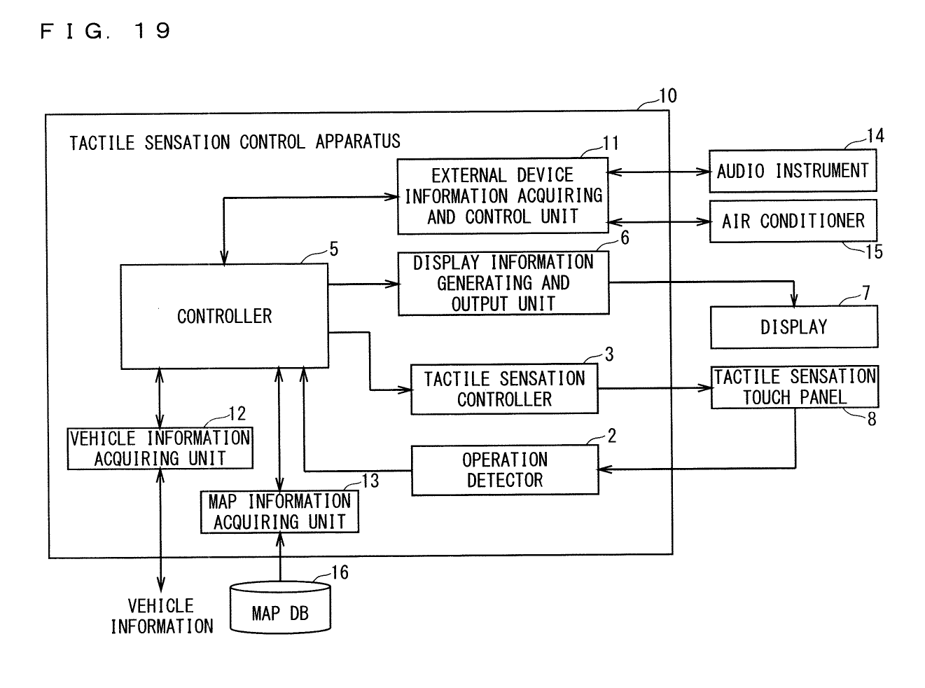

In a case where the tactile sensation of the area of the operation icon 9 is made constant in level and is gradually shortened in interval with a lapse of time as exemplified in FIG. 18, determination can be made such that a user operates the tactile sensation touch panel 8 (operation is valid) if the interval becomes shorter than a predetermined threshold (if time t=T2). This achieves prevention of erroneous operation and reliable receipt of operation intended by a user.

Only light (at a pressure less than a predetermined level) touch (predetermined first operation or preliminary icon operation) of the operation icon 9 may not be determined as icon operation, but touch to press the operation icon 9 (at a pressure equal to or more than the predetermined level) (predetermined second operation or icon operation) can be determined as icon operation. In this case, the area of the operation icon 9 can have tactile sensation change when the operation icon 9 is touched to press the icon (change in second tactile sensation), or can have tactile sensation change in a period from light touch to press touch (change in first tactile sensation). Alternatively, tactile sensation change can be made in a manner of combination thereof. The area of the operation icon 9 can have tactile sensation change in any one of the above manners. This achieves prevention of erroneous operation and reliable receipt of operation intended by a user.

As described above, tactile sensation change is made in accordance with receipt of user operation in the present embodiment 1, so that a user does not need to visually focus on the display screen during operation. This enables convenient operation for the user.

The function according to the embodiment 1 is also applicable to a smartphone. The smartphone, which may be operated by a walking user, effectively prevents deterioration in attention to the surrounding situation.

### Embodiment 2

Initially described will be a configuration of a tactile sensation control apparatus according to the present embodiment 2 of the present invention.

FIG. 19 is a block diagram depicting an exemplary configuration of a tactile sensation control apparatus 10 according to the present embodiment 2.

As depicted in FIG. 19, the tactile sensation control apparatus 10 includes an external device information acquiring and control unit 11, a vehicle information acquiring unit 12, and a map information acquiring unit 13. The external device information acquiring and control unit 11 is connected with an audio instrument 14 and an air conditioner 15, while the map information acquiring unit 13 is connected with a map database (DB) 16. The other configurations are similar to those according to the embodiment 1 (see FIG. 7) and will not herein be described repeatedly.

The external device information acquiring and control unit 11 acquires external device information (operation target device information) or information on external devices (the audio instrument 14 and the air conditioner 15) to be operated by a user. In other words, the external device information acquiring and control unit 11 functions as an operation target device information acquiring unit. The external device information acquiring and control unit 11 also controls the external devices (the audio instrument 14 and the air conditioner 15).

The vehicle information acquiring unit 12 acquires, via an in-vehicle local area network (LAN), vehicle information such as sensor information detected by various sensors provided in the vehicle (e.g. vehicle speed pulse information), vehicle control information, or global positioning system (GPS) information.

The map information acquiring unit 13 acquires map information from the map DB 16.

The map DB 16 stores map information. The map DB 16 can be mounted on the vehicle or be provided externally.

Behaviors of the tactile sensation control apparatus 10 will be described next.

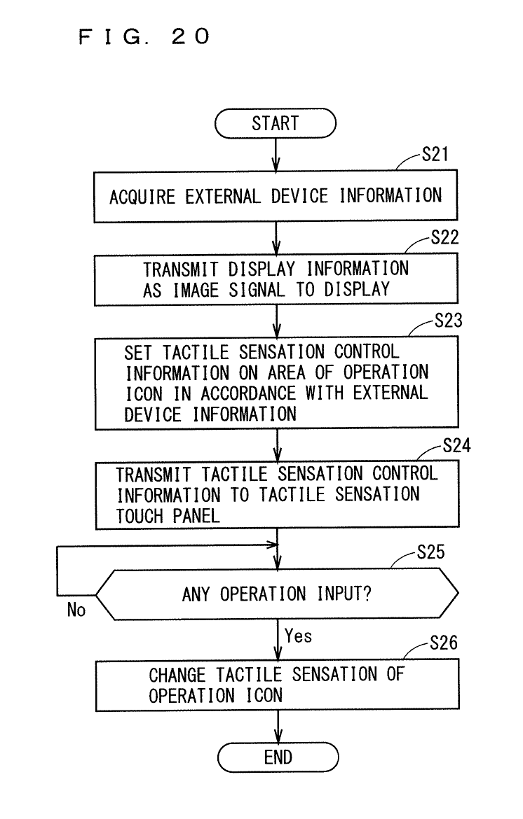

FIG. 20 is a flowchart of exemplary behaviors of the tactile sensation control apparatus 10. Steps S22 and S24 to S26 in FIG. 20 correspond to steps S11 and S13 to S15 in FIG. 8, and will not herein be described repeatedly.

In step S21, the external device information acquiring and control unit 11 acquires external device information from the external devices (the audio instrument 14 or the air conditioner 15). The acquired external device information is transmitted to the controller 5.

In step S23, the tactile sensation controller 3 sets tactile sensation control information on the areas of the operation icons 9 in accordance with a command from the controller 5. Specifically, the tactile sensation controller 3 sets the tactile sensation control information in accordance with the external device information acquired by the external device information acquiring and control unit 11 such that the external devices and functions of the external devices each have a different tactile sensation.

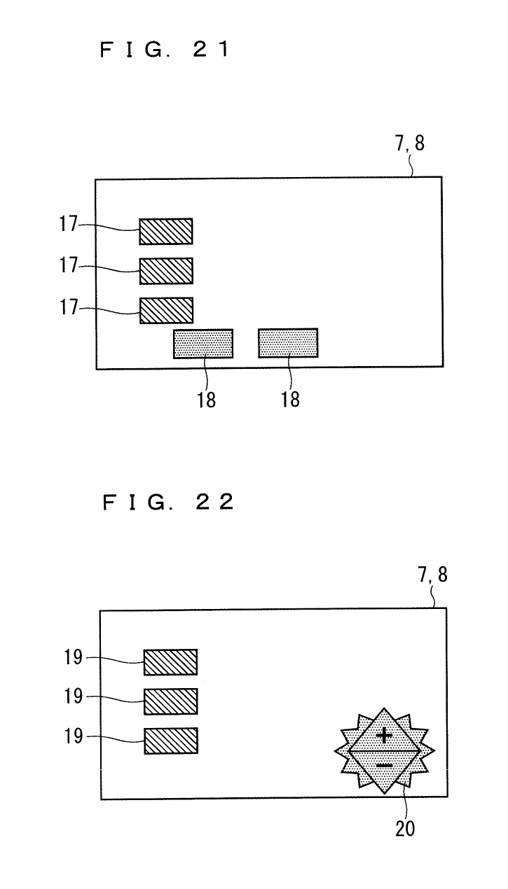

Exemplary specific behaviors of the tactile sensation control apparatus 10 will be described next with reference to FIG. 21.

The display screen of the display 7 in FIG. 21 includes navigation operation icons 17 and air conditioner operation icons 18. On the tactile sensation touch panel 8, the areas of the navigation operation icons 17 have a “rough” tactile sensation, the areas of the air conditioner operation icons 18 have a “semi-rough” tactile sensation, and the area other than the navigation operation icons 17 and the air conditioner operation icons 18 has a “smooth” tactile sensation.

A user touches the navigation operation icon 17 to perform operation relevant to navigation (e.g. operation for route search from the current position to a destination). In a case where the user touches the navigation operation icon 17, the controller 5 performs processing relevant to navigation such as route search in accordance with the vehicle information acquired by the vehicle information acquiring unit 12 and the map information acquired by the map information acquiring unit 13. The controller 5 is assumed to have a navigation function.

A user touches the air conditioner operation icon 18 to perform operation relevant to the air conditioner 15 (e.g. temperature adjusting operation). In a case where the user touches the air conditioner operation icon 18, the controller 5 issues a command to the external device information acquiring and control unit 11 to control the air conditioner 15. The external device information acquiring and control unit 11 controls the air conditioner 15 in accordance with the command from the controller 5.

As described above, the navigation operation icons 17 and the air conditioner operation icons 18 have different tactile sensations. When a user touches the navigation operation icon 17 or the air conditioner operation icon 18 under this condition, the area of the navigation operation icon 17 or the air conditioner operation icon 18 has different tactile sensation change. For example, touch of the navigation operation icon 17 causes tactile sensation change in the order of “rough”, “moving rough”, and “rough” tactile sensations, whereas touch of the air conditioner operation icon 18 causes tactile sensation change in the order of “semi-rough”, “rough”, and “semi-rough” tactile sensations. Each of the external devices can optionally have a different period necessary for change of each tactile sensation. Such differentiation in icon tactile sensation change between the external devices allows a user to easily find which one of the devices is operated.

FIG. 21 illustrates the case where the external devices each have different icon tactile sensation change, but does not intend to limit the present invention. Each of the functions of the external devices can have different tactile sensation change. In a case where FIG. 21 depicts an audio visual (AV) screen including a volume adjusting icon and a tuning icon, an area of the volume adjusting icon and an area of the tuning icon can each have different tactile sensation change. This allows a user to easily find which one of the functions is operated.

In a case where icons on the display screen of the display 7 have different shapes for respective functions thereof, each of the icons can have different tactile sensation change. In a case where, as depicted in FIG. 22, the display screen of the display 7 is an AV screen including tuning icons 19 and a volume adjusting icon 20, areas of the tuning icons 19 and an area of the volume adjusting icon 20 can each have different tactile sensation change. The tuning icons 19 each have a shape like a press button while the volume adjusting icon 20 has a shape like a dial. This configuration allows a user to easily find what type of icon is operated.

Icon tactile sensation change caused by touch operation can be made in size as depicted in FIG. 13. Tactile sensation change of an icon for a dial configured to turn or an icon configured to turn can be made by rotation as depicted in FIG. 15. Such tactile sensation change achieves expression of a physically pressed switch, a jog switch, a turnable switch, or the like by means of tactile sensation and enables convenient operation.

As described above, tactile sensation change in areas of icons is differentiated for each external device (for each device to be operated) or each function of external devices (for each function of devices to be operated) in the present embodiment 2, so as to allow a user to select and operate an intended icon. This enables convenient operation for the user.

### Embodiment 3

The embodiment 3 of the present invention will refer to a case where the tactile sensation touch panel 8 extends to reach an area (non-display area) outside the display screen (display area) of the display 7 (i.e. a case where the operation surface of the tactile sensation touch panel 8 planarly includes the display area for displaying information and the non-display area outside the display area). A tactile sensation control apparatus according to the present embodiment 3 is configured similarly to the tactile sensation control apparatus 10 according to the embodiment 2 (see FIG. 19) and will not herein be described repeatedly.

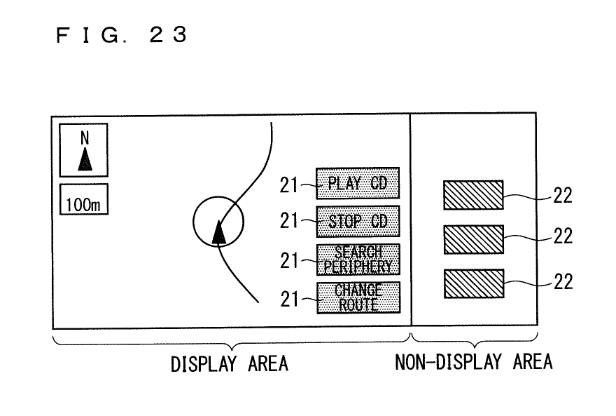

FIG. 23 is a diagram depicting an exemplary behavior of the tactile sensation control apparatus according to the present embodiment 3.

FIG. 23 depicts the display screen of the display 7 corresponding to the display area and the area of the tactile sensation touch panel 8 corresponding an area including the display area and the non-display area. The display screen of the display 7 includes a position of the vehicle on a map and operation icons 21 for various operation (“play CD”, “stop CD”, “search periphery”, and “change route”). On the tactile sensation touch panel 8, areas of the operation icons 21 in the display area have a “semi-rough” tactile sensation whereas areas of operation icons 22 in the non-display area have a “rough” tactile sensation. The areas of the operation icons 21 and the area of the operation icons 22 are different in tactile sensation change when a user performs operation. The areas of the operation icons 21 and the areas of the operation icons 22 can each have tactile sensation change in any one of the manners described in the embodiment 1.

Examples of the operation icons 22 include an operation button for a function of the air conditioner 15, an operation button for an AV function, and an operation button for a navigation function. The operation icons 22 can each have a physically rising shape.

As described above, tactile sensation change is differentiated between the area corresponding to the display area and the area corresponding to the non-display area on the operation surface of the tactile sensation touch panel 8 according to the present embodiment 3, so as to allow a user to select and operate an intended icon. This enables convenient operation for the user.

### Embodiment 4

The tactile sensation controller 3 according to the embodiment 4 of the present invention is configured to provide a predetermined tactile sensation if a user performs erroneous operation. A tactile sensation control apparatus according to the present embodiment 4 is configured similarly to the tactile sensation control apparatus 10 according to the embodiment 2 (see FIG. 19) and will not herein be described repeatedly.

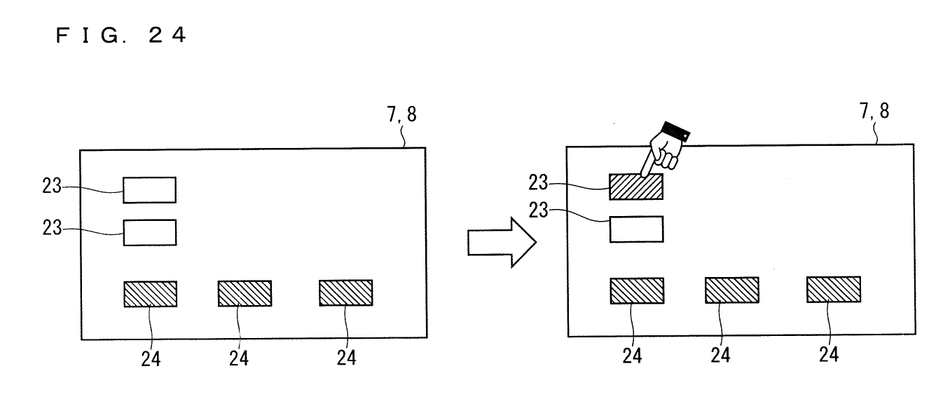

FIG. 24 is a diagram depicting an exemplary behavior of the tactile sensation control apparatus according to the present embodiment 4. FIG. 24 depicts display and tactile sensations while the vehicle is travelling.

The display screen of the display 7 includes travelling operation restriction icons 23 and travelling operation non-restriction icons 24. On the tactile sensation touch panel 8, areas of the travelling operation restriction icons 23 have a “smooth” tactile sensation, areas of the travelling operation non-restriction icons 24 have a “rough” tactile sensation, and the area other than the travelling operation restriction icons 23 and the travelling operation non-restriction icons 24 has a “smooth” tactile sensation.

Specifically, the travelling operation restriction icons 23, to which operation is invalid while the vehicle is travelling, have a “smooth” tactile sensation. Meanwhile, the travelling operation non-restriction icons 24, to which operation is always valid regardless of the vehicle travel state, have a “rough” tactile sensation. The travelling operation restriction icons 23 can alternatively be configured to invalidate operation while the vehicle is travelling and validate operation while the vehicle is stopping. Examples of the travelling operation restriction icons 23 include various operation icons on a navigation screen. The controller 5 is assumed to have a navigation function in this case. Examples of the travelling operation non-restriction icons 24 include the volume adjusting icon of the audio instrument 14 and a temperature adjusting icon of the air conditioner 15.

When a user touches to operate one of the travelling operation restriction icons 23 (the upper travelling operation restriction icon 23 in the figure) in the state of the left portion in FIG. 24, the tactile sensation of the area of the touched travelling operation restriction icon 23 is changed to a “moving rough” tactile sensation as depicted in the right portion in FIG. 24. In other words, user's touch to an area accepting no operation will cause tactile sensation change in the touched area.

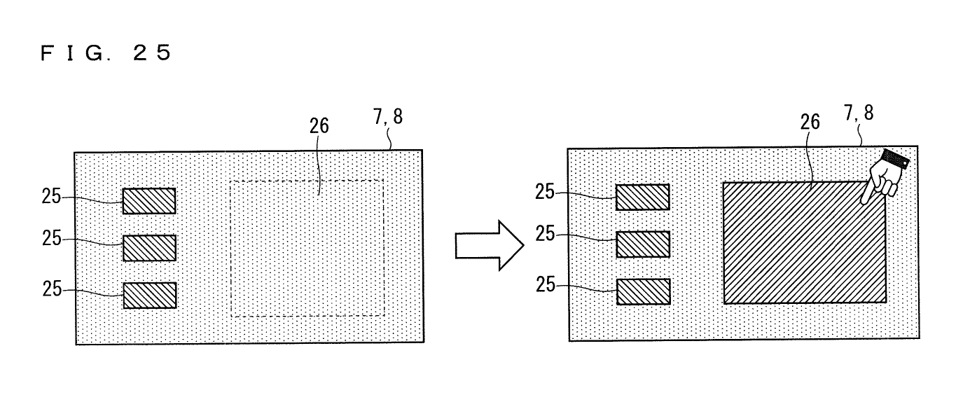

FIG. 25 is a diagram depicting another exemplary behavior of the tactile sensation control apparatus according to the present embodiment 4. FIG. 25 depicts display and tactile sensations while the vehicle is travelling.

The display screen of the display 7 includes operation icons 25. On the tactile sensation touch panel 8, areas of the operation icons 25 have a “rough” tactile sensation while the area other than the operation icons 25 has a “semi-rough” tactile sensation. The left portion in FIG. 25 depicts an area surrounded with a broken line corresponding to a gesture input area 26. The gesture input area on the display screen of the display 7 allows a user to input through gesture operation. The operation icons 25 can be the same as the travelling operation non-restriction icons 24 depicted in FIG. 24.

Specifically, the gesture input area 26, to which operation is invalid while the vehicle is travelling, has a “semi-rough” tactile sensation. Meanwhile, the operation icons 25, to which operation is valid regardless of the vehicle travel state, have a “rough” tactile sensation. The gesture input area 26 can alternatively be configured to invalidate operation while the vehicle is travelling and validate operation while the vehicle is stopping.

When a user touches the gesture input area 26 for gesture operation in the state of the left portion in FIG. 25, the tactile sensation of the touched gesture input area 26 is changed to a “moving rough” tactile sensation as depicted in the right portion in FIG. 25. In other words, when the user performs restricted operation, the operated area has tactile sensation change.

As described above, when the user touches an icon or an area accepting no operation (performs operation to an area accepting no operation or performs an operation restricted under a predetermined condition), the user can find erroneous operation with tactile sensation change in the touched area.

In this case, the touched area can have tactile sensation change when the user touches the area accepting no operation regardless of whether the vehicle is travelling or stopping. Tactile sensation change can be made by deformation of the area providing the tactile sensation (see, for example, FIGS. 13 to 15).

As described above, according to the present embodiment 4, the tactile sensation changes in a case where erroneous operation is performed and thus allows a user to easily find that erroneous operation is performed. This enables convenient operation for the user.

### Embodiment 5

The tactile sensation controller 3 according to the embodiment 5 of the present invention controls to cause positional change in tactile sensation following movement of user's gesture operation. A tactile sensation control apparatus according to the present embodiment 5 is configured similarly to the tactile sensation control apparatus 4 according to the embodiment 1 (see FIG. 7) or the tactile sensation control apparatus 10 according to the embodiment 2 (see FIG. 19), and will not herein be described repeatedly.

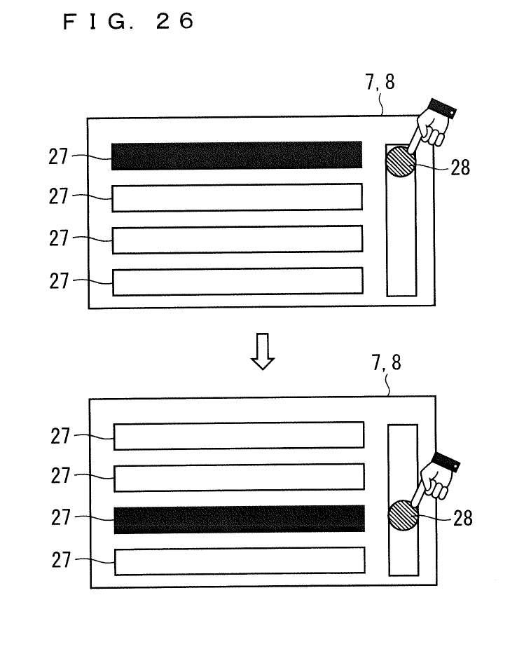

FIG. 26 is a diagram depicting an exemplary behavior of the tactile sensation control apparatus according to the present embodiment 5.

The display screen of the display 7 includes appropriate items 27, and a scrolling operation icon 28 provided at the right end of the screen. An area of the scrolling operation icon 28 has a “rough” tactile sensation on the tactile sensation touch panel 8.

A user slides the scrolling operation icon 28 vertically on the screen depicted in FIG. 26 to select one of the items 27. Such sliding operation is performed by sliding while the user is touching the operation surface of the tactile sensation touch panel 8, and is conceptually included in gesture operation.

The upper portion in FIG. 26 depicts a state where a user touches the scrolling operation icon 28 in order to perform sliding operation. The uppermost item 27 on the screen is selected in this case and the area of the scrolling operation icon 28 has a “rough” tactile sensation. As depicted in the lower portion in FIG. 26, when the user subsequently slides the scrolling operation icon 28 downward on the screen, the third item 27 from the top of the screen is selected, following the sliding operation. The tactile sensation of the area of the scrolling operation icon 28 is positionally changed (moved), following the sliding operation.

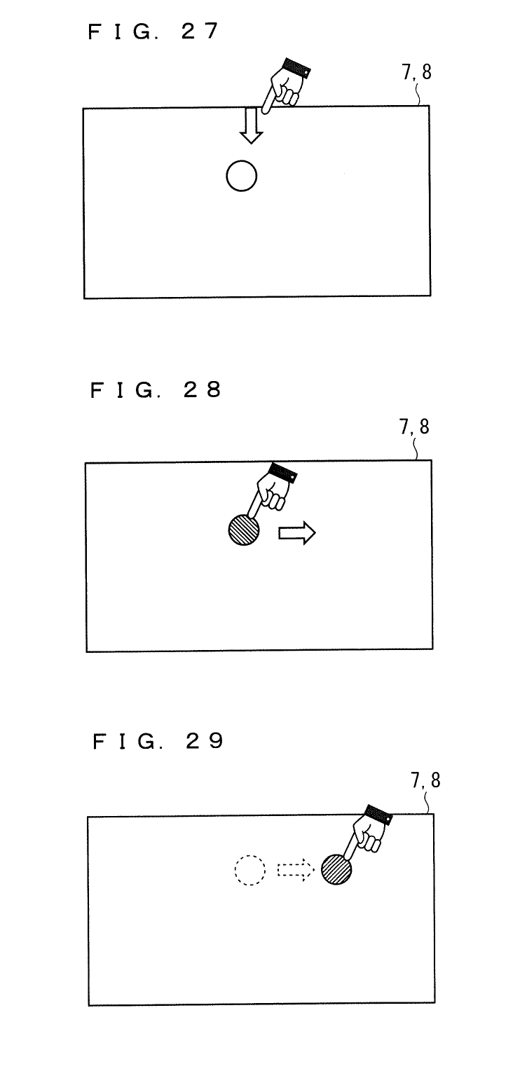

FIGS. 27 to 31 are diagrams each depicting another exemplary behavior of the tactile sensation control apparatus according to the present embodiment 5. Broken circles in FIGS. 29 to 31 indicate a position initially touched by a user.

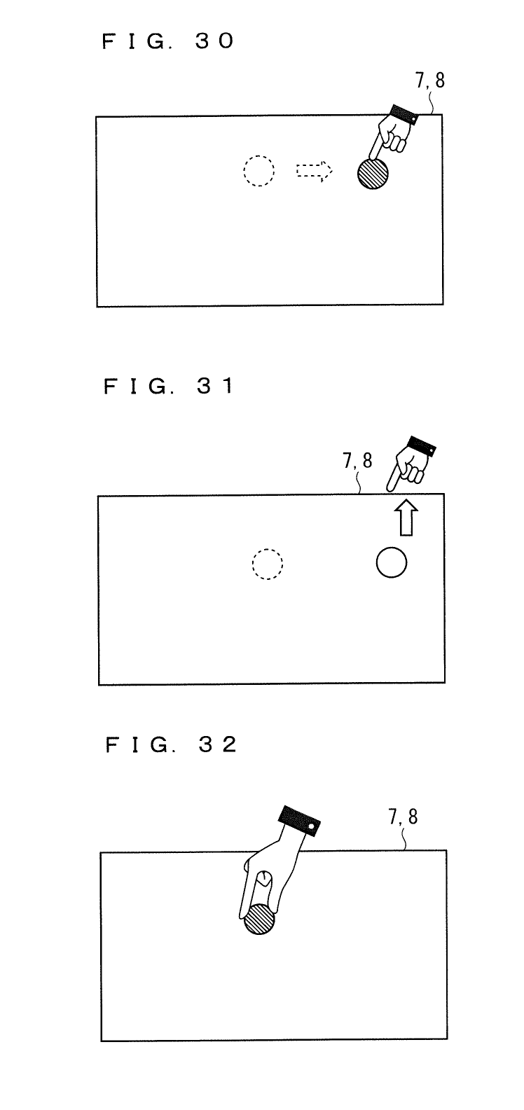

The operation surface of the tactile sensation touch panel 8 has a “smooth” tactile sensation before the user touches the operation surface of the tactile sensation touch panel 8 as depicted in FIG. 27. When the user touches the operation surface, the tactile sensation of the area of the touched position is changed to a “rough” tactile sensation as depicted in FIG. 28. When the user subsequently performs gesture operation, the tactile sensation is positionally changed (moved), following movement of the gesture operation as depicted in FIG. 29. The tactile sensation is changed to a “moving rough” tactile sensation in this state. When the user subsequently stops the gesture operation, the tactile sensation is changed to a “rough” tactile sensation as depicted in FIG. 30. When the user subsequently stops touching the operation surface, the tactile sensation is changed to a “smooth” tactile sensation (although the user does not obtain a “smooth” tactile sensation) as depicted in FIG. 31. The tactile sensation controller 3 can alternatively control to cause tactile sensation change according to speed of the gesture operation in FIGS. 27 to 31. In this manner, the tactile sensation controller 3 controls to differentiate between the tactile sensation at the start or end of gesture operation and the tactile sensation during the gesture operation. This allows a user to easily recognize that the gesture operation is performed correctly.

The behaviors depicted in FIGS. 27 to 31 are applicable to, for example, relocation of an operation icon (displayed object) on the display screen of the display 7.

FIGS. 32 to 34 are diagrams each depicting still another exemplary behavior of the tactile sensation control apparatus according to the present embodiment 5. Gesture operation performed as depicted in the order of FIGS. 32, 33, and 34 will particularly be called pinching-out operation, while gesture operation performed as depicted in the order of FIGS. 34, 33, and 32 will particularly be called pinching-in operation. The pinching-out operation will exemplarily be described below.

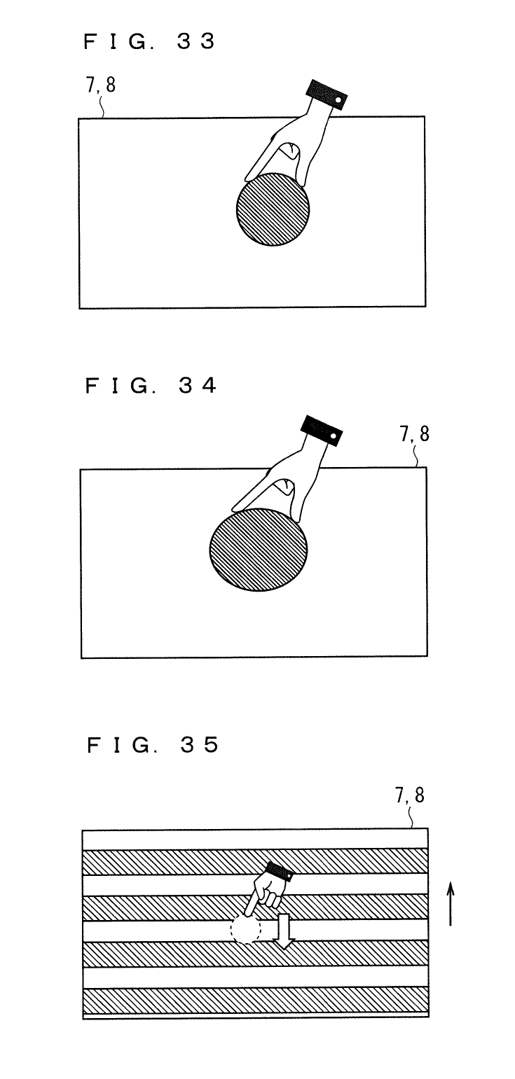

When a user touches two points on the operation surface as depicted in FIG. 32, a predetermined area having ends including these two points (a circular area in this case) has a “rough” tactile sensation. When the user subsequently slides these two points so as to be apart from each other, the area depicted in FIG. 32 expands following this sliding operation as depicted in FIGS. 33 and 34. The area has a “rough” tactile sensation in this state.

As depicted in FIGS. 32 to 34, the operated area has a “rough” tactile sensation in a case where a user performs the pinching-out operation or the pinching-in operation. Meanwhile, the operated area has a “moving rough” tactile sensation in a case where a user performs operation (e.g. dragging operation) as depicted in FIGS. 27 to 31. In other words, the tactile sensation controller 3 controls to differentiate tactile sensations during gesture operation depending on types of the gesture operation. This allows a user to easily recognize what type of gesture operation is received.

In FIGS. 26 to 34, the tactile sensations (“smooth”, “semi-rough”, “rough”, and “moving rough” tactile sensations) can be combined appropriately. The pinching-out operation or the pinching-in operation depicted in FIGS. 32 to 34 can cause tactile sensation change in a pinched border line area.

As described above, according to the present embodiment 5, the position of a tactile sensation changes (moves) following movement of gesture operation, so as to allow a user to easily recognize that the gesture operation is performed correctly. Tactile sensations during gesture operation are differentiated depending on types of the gesture operation, so that a user easily recognizes what type of gesture operation is received.

### Embodiment 6

The tactile sensation controller 3 according to the embodiment 6 of the present invention controls tactile sensation change at least in an area of gesture operation performed on the operation surface, in accordance with movement of gesture operation. A tactile sensation control apparatus according to the present embodiment 6 is configured similarly to the tactile sensation control apparatus 4 according to the embodiment 1 (see FIG. 7) or the tactile sensation control apparatus 10 according to the embodiment 2 (see FIG. 19), and will not herein be described repeatedly.

FIGS. 35 to 38 are diagrams each depicting an exemplary behavior of the tactile sensation control apparatus according to the present embodiment 6. Broken circles in FIGS. 35 to 38 indicate a position touched by a user.

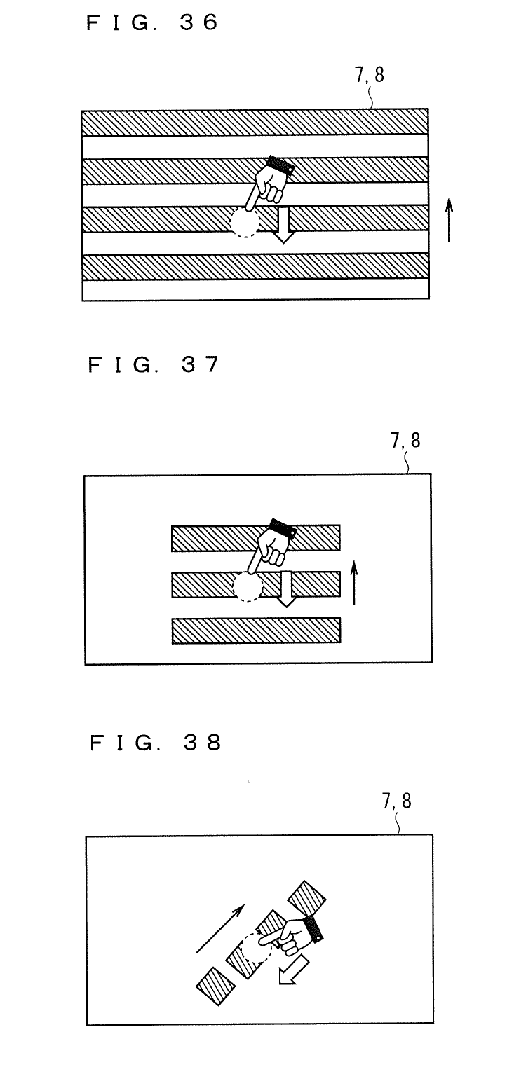

As depicted in FIGS. 35 and 36, the entire operation surface of the tactile sensation touch panel 8 has a “rough” tactile sensation and a “smooth” tactile sensation provided alternately along user's gesture operation (e.g. scrolling operation). Areas having a “rough” tactile sensation and areas having a “smooth” tactile sensation provided on the entire operation surface move in the direction opposite to the gesture operation. A “rough” tactile sensation and a “smooth” tactile sensation are positionally changed in this case, but may not necessarily be positionally changed. This is because a finger drags on the operation surface to alternately obtain a “rough” tactile sensation and a “smooth” tactile sensation.

As depicted in FIGS. 37 and 38, the operation surface of the tactile sensation touch panel 8 partially has a “rough” tactile sensation and a “smooth” tactile sensation provided alternately along user's gesture operation (e.g. scrolling operation). Areas having a “rough” tactile sensation and areas having a “smooth” tactile sensation provided on the entire operation surface move in the direction opposite to the gesture operation.

In FIGS. 35 to 38, the areas having the respective tactile sensations provided on the operation surface can be moved for a while when a user stops gesture operation (the user is touching the operation surface in this case). This allows the user to feel inertia of gesture operation at the end thereof.

In FIGS. 35 to 38, the areas having the respective tactile sensation provided on the operation surface may not necessarily be moved upon gesture operation. The areas having the respective tactile sensation on the operation surface can alternatively move along gesture operation. The areas having the respective tactile sensation on the operation surface preferably move faster than gesture operation in this case.

In FIGS. 35 to 38, the tactile sensations (“smooth”, “semi-rough”, “rough”, and “moving rough” tactile sensations) can be combined appropriately.

The above example refers to the case where there are a “smooth” tactile sensation and a “rough” tactile sensation, but does not intend to limit the present invention. For example, a “semi-rough” or “moving rough” tactile sensation can be combined appropriately.

As described above, according to the present embodiment 6, the tactile sensation changes at least in an area of gesture operation performed on the operation surface in accordance with movement of the gesture operation, so as to allow a user to easily recognize that the gesture operation is performed correctly.

### Embodiment 7

The tactile sensation controller 3 according to the embodiment 7 of the present invention controls to change an area of a tactile sensation following movement of user's gesture operation. A tactile sensation control apparatus according to the present embodiment 7 is configured similarly to the tactile sensation control apparatus 4 according to the embodiment 1 (see FIG. 7) or the tactile sensation control apparatus 10 according to the embodiment 2 (see FIG. 19), and will not herein be described repeatedly.

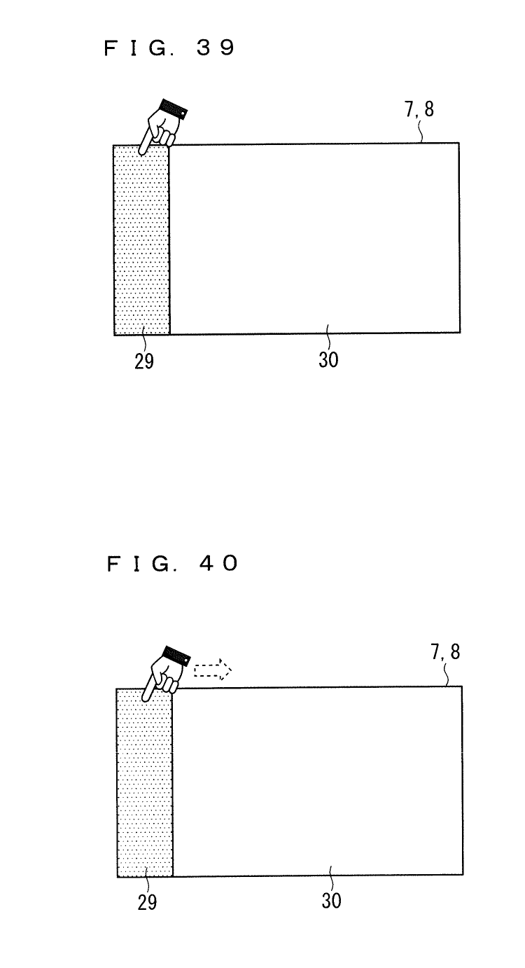

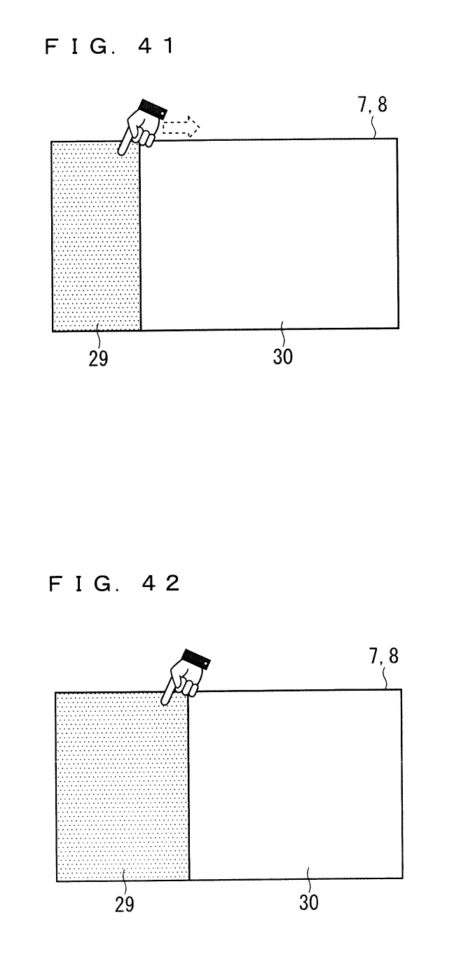

FIGS. 39 to 43 are diagrams each depicting an exemplary behavior of the tactile sensation control apparatus according to the present embodiment 7.

The display screen of the display 7 includes display areas 29 and 30. On the tactile sensation touch panel 8, the display area 29 has a “semi-rough” tactile sensation and the display area 30 has a “smooth” tactile sensation.

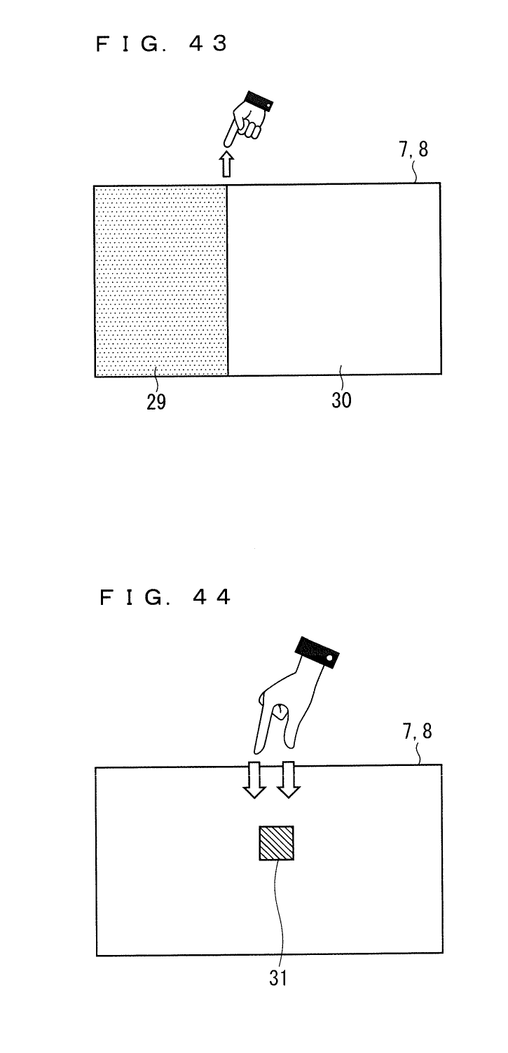

When a user touches the display area 29 and slides the area to the right in the figure, the display area 29 expands following movement of the sliding operation while the display area 30 decreases as depicted in FIGS. 39 to 42. An area having the tactile sensation in the display area 29 expands along with the display area 29, while an area having the tactile sensation in the display area 30 decreases along with the display area 30. As depicted in FIG. 43, the display areas 29 and 30 are fixed in size when the user subsequently stops touching.

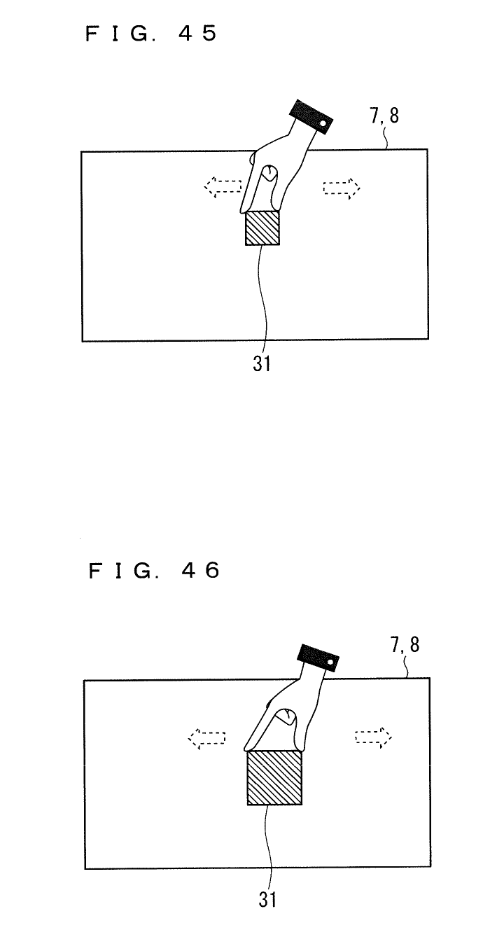

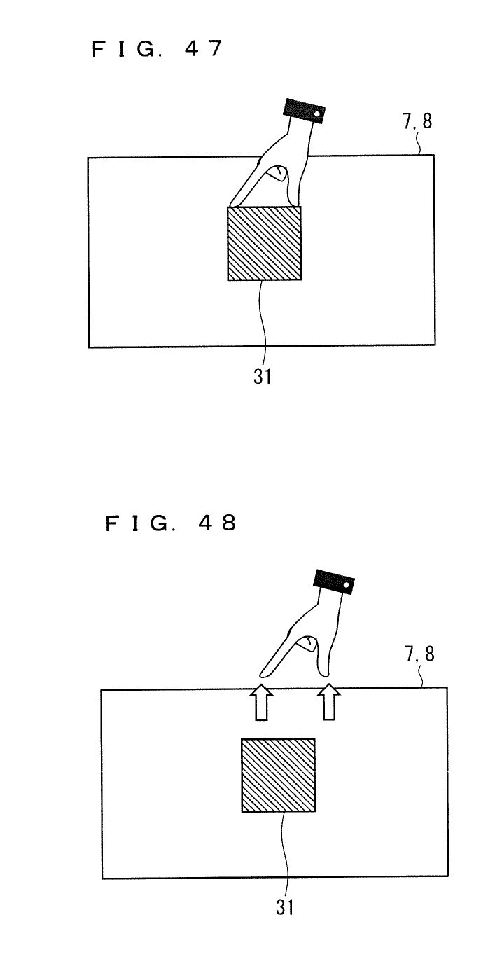

FIGS. 44 to 48 are diagrams each depicting another exemplary behavior of the tactile sensation control apparatus according to the present embodiment 7.

The display screen of the display includes a display area 31. The display area 31 has a “rough” tactile sensation on the tactile sensation touch panel 8.

When a user performs pinching-out operation in order to expand the display area 31, the display area 31 expands following movement of the pinching-out operation as depicted in FIGS. 44 to 47. An area having the tactile sensation in the display area 31 expands along with the display area 31. As depicted in FIG. 48, the display area 31 is fixed in size when the user subsequently stops touching.

In FIGS. 39 to 48, the tactile sensations (“smooth”, “semi-rough”, “rough”, and “moving rough” tactile sensations) can be combined appropriately.

As described above, the present embodiment 7 causes change in an area having a tactile sensation following movement of gesture operation, so as to allow a user to easily recognize that the gesture operation is performed correctly.

The tactile sensation control apparatus described above is applicable to an on-vehicle navigation system or a car navigation system, as well as a vehicle-mountable portable navigation device (PND), a mobile communication terminal (e.g. a mobile phone, a smartphone, or a tablet terminator), a navigation device built up as a system in appropriate combination with a server or the like, and a device other than the navigation device. In this case, the functions or the constituent elements of the tactile sensation control apparatus are distributed to functions configuring the system.

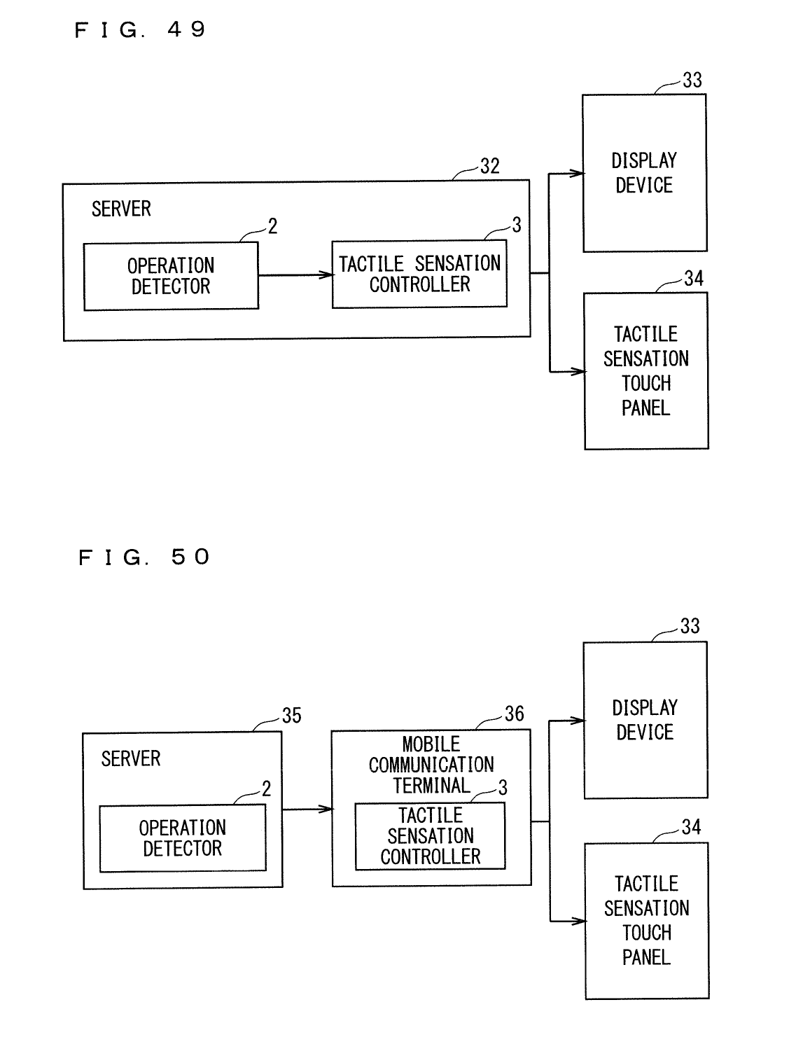

Specifically, according to an example, the functions of the tactile sensation control apparatus can be provided at a server. As exemplified in FIG. 49, a tactile sensation control system is built up with including a display device 33 and a tactile sensation touch panel 34 at a user's end as well as a server 32 provided with at least the operation detector 2 and the tactile sensation controller 3. The operation detector 2 and the tactile sensation controller 3 function similarly to the operation detector 2 and the tactile sensation controller 3 depicted in FIG. 1, respectively. The server 32 can alternatively include the constituent elements depicted in FIGS. 7 and 19 as necessary. In this case, the constituent elements included in the server 32 can appropriately be distributed to the server 32 and the display device 33.

According to another example, the functions of the tactile sensation control apparatus can be provided at the server and a mobile communication terminal. As exemplified in FIG. 50, a tactile sensation control system is built up with including the display device 33 and the tactile sensation touch panel 34 at the user's end, a server 35 provided with at least the operation detector 2, and a mobile communication terminal 36 provided with at least the tactile sensation controller 3. The operation detector 2 and the tactile sensation controller 3 function similarly to the operation detector 2 and the tactile sensation controller 3 depicted in FIG. 1, respectively. The server 35 and the mobile communication terminal 36 can alternatively include the constituent elements depicted in FIGS. 7 and 19 as necessary. In this case, the constituent elements included in the server 35 and the mobile communication terminal 36 can appropriately be distributed to the display device 33, the server 35, and the mobile communication terminal 36.

The above configuration also achieves effects similar to those of the above embodiments.

Software (a tactile sensation control method) configured to execute the behaviors mentioned in the above embodiments can be incorporated in a server, a mobile communication terminal, or the like.

Specifically, the tactile sensation control method is exemplary for controlling a tactile sensation of a user operating an operation surface of a touch panel or a touch pad. The method includes: detecting operation by the user to the operation surface; and controlling the tactile sensation on the operation surface to change, with a lapse of time, a tactile sensation of an area receiving the detected operation by the user or an area following movement of the detected operation by the user.

As described above, the software configured to execute the behaviors mentioned in the above embodiments can be incorporated in a server or a mobile communication terminal to achieve effects similar to those of the above embodiments.

The operation detector 2, the tactile sensation controller 3, the controller 5, the display information generating and output unit 6, the external device information acquiring and control unit 11, the vehicle information acquiring unit 12, and the map information acquiring unit 13 depicted in FIGS. 1, 7, 19, 49, and 50 are each embodied by processing a program using a central processing unit (CPU) according to the software. Where possible, the operation detector 2, the tactile sensation controller 3, the controller 5, the display information generating and output unit 6, the external device information acquiring and control unit 11, the vehicle information acquiring unit 12, and the map information acquiring unit 13 are each configured as hardware (e.g. an arithmetic/processing circuit configured to perform specific calculation or processing to an electric signal). The both configurations described above can alternatively be provided together.

The embodiments 1 to 7 refer to the case where the display 7 and the tactile sensation touch panel 8 are provided integrally with each other (where the tactile sensation touch panel 8 is provided on the display screen of the display 7), but can adopt any other configuration. For example, the display 7 can be provided at a meter panel of a vehicle instrument panel unit while the tactile sensation touch panel 8 can be configured as a separate tactile sensation touch pad provided at a different site from the meter panel. Such a configuration also allows a user to operate icons on the display 7 provided at the meter panel without viewing the tactile sensation touch pad. This enables convenient operation for the user. The display 7 provided at the meter panel can have a display area entirely or partially occupying the area of the meter panel. An area generating tactile sensations on the tactile sensation touch pad and the display area of the display 7 can be sized equally, similarly, or not similarly to each other.

The present invention also includes free combination of the embodiments as well as appropriate modification of and removal from the embodiments within the scope of the invention.

The above detailed description of the present invention should be exemplary in every aspect and should not limit the scope of the invention. Infinite modification examples not described herein should not to be excluded from the scope of the invention.

### REFERENCE SIGNS LIST

1: tactile sensation control apparatus
2: operation detector
3: tactile sensation controller
4: tactile sensation control apparatus
5: controller
6: display information generating and output unit
7: display
8: tactile sensation touch panel
9: operation icon
10: tactile sensation control apparatus
11: external device information acquiring and control unit
12: vehicle information acquiring unit
13: map information acquiring unit
14: audio instrument
15: air conditioner
16: map DB
17: navigation operation icon
18: air conditioner operation icon
19: tuning icon
20: volume control icon
21,22: operation icon
23: travelling operation restriction icon
24: travelling operation non-restriction icon
25: operation icon
26: gesture input area
27: item
28: scrolling operation icon
29,30,31: display area
32: server
33: display device
34: tactile sensation touch panel
35: server
36: mobile communication terminal

1-20. (canceled)

21. A tactile sensation control system configured to control a tactile sensation of a user operating an operation surface of a touch panel or a touch pad, the system comprising:
a processor to execute a program; and
a memory to store the program which, when executed by the processor, performs processes of:
detecting an operation by said user to said operation surface; and
controlling, when it is detected in said detecting that said user is operating one of an icon operation and a gesture operation, said tactile sensation on said operation surface while said user is operating said one of said icon operation and said gesture operation so that a tactile sensation on an area receiving said one of said icon operation and said gesture operation changes with a lapse of time in accordance with a predetermined tactile sensation change rule.

22. The tactile sensation control system according to claim 21, wherein said controlling includes controlling said tactile sensation on said operation surface so that a position of said tactile sensation on said area receiving said icon operation changes with a lapse of time.

23. The tactile sensation control system according to claim 21, wherein said controlling includes controlling said tactile sensation on said operation surface so that a pattern of said tactile sensation on said area receiving said icon operation changes with a lapse of time.

24. The tactile sensation control system according to claim 22, wherein
said controlling includes controlling said tactile sensation so that said position of said tactile sensation discontinuously changes.

25. The tactile sensation control system according to claim 22, wherein said controlling includes controlling said tactile sensation so that said position of said tactile sensation shifts from a first position to a second position.

26. The tactile sensation control system according to claim 22, wherein said controlling includes controlling said tactile sensation so that a level of a tactile sensation on a part of said area receiving said icon operation dynamically changes.

27. The tactile sensation control system according to claim 22, wherein said controlling includes controlling said tactile sensation so that said area receiving said icon operation changes with a lapse of time.

28. The tactile sensation control system according to claim 27, wherein
in a case where an operation icon configured to receive said operation is displayed correspondingly on said operation surface,
said operation icon is displayed in a changed manner in accordance with change in tactile sensation caused by said controlling, in said area receiving said icon operation.

29. The tactile sensation control system according to claim 21, wherein
in a case where an operation icon configured to receive said operation is displayed correspondingly on said operation surface,
in said controlling, said tactile sensation is controlled so that a first tactile sensation is generated when a preliminary icon operation that is a predetermined first operation is detected and so that a second tactile sensation is generated when an icon operation that is a predetermined second operation is detected, and said operation is determined as valid when said second operation is detected.

30. The tactile sensation control system according to claim 21, wherein said controlling includes changing a level of said tactile sensation and controlling said tactile sensation so that said tactile sensation is generated at regular intervals, or keeping said level of said tactile sensation constant and controlling said tactile sensation so that said tactile sensation is generated at irregular intervals.

31. The tactile sensation control system according to claim 21, wherein
said controlling includes controlling said tactile sensation so that a position of said tactile sensation on said area receiving said gesture operation changes in accordance with movement of said gesture operation.

32. The tactile sensation control system according to claim 31, wherein
said controlling includes controlling said tactile sensation so that a tactile sensation at start of said gesture operation differs from a tactile sensation during said gesture operation and said tactile sensation during said gesture operation differs from a tactile sensation at end of said gesture operation.

33. The tactile sensation control system according to claim 21, further comprising
a display configured to display information, wherein,
said touch pad is provided separately from said display.

34. The tactile sensation control system according to claim 21, wherein said controlling includes controlling said tactile sensation so that said user has a predetermined tactile sensation in a case where said user erroneously performs said operation.

35. The tactile sensation control system according to claim 34, wherein erroneously performing said operation includes performing said operation to an area accepting no operation or performing an operation restricted under a predetermined condition.

36. The tactile sensation control system according to claim 21, wherein
said operation surface of said touch panel planarly includes a display area for displaying information and a non-display area other than said display area, and
said controlling includes controlling said tactile sensation so that said tactile sensation changes differently between an area corresponding to said display area and an area corresponding to said non-display area on said operation surface.

37. A tactile sensation control method of controlling a tactile sensation of a user operating an operation surface of a touch panel or a touch pad, the method comprising:
detecting an operation by said user to said operation surface; and
controlling, when it is detected that said user is operating one of an icon operation and a gesture operation, said tactile sensation on said operation surface while said user is operating said one of said icon operation and said gesture operation so that a tactile sensation on an area receiving said one of said icon operation and said gesture operation changes with a lapse of time in accordance with a predetermined tactile sensation change rule.

38. The tactile sensation control method according to claim 37, wherein said controlling includes controlling said tactile sensation on said operation surface so that a position of said tactile sensation on said area receiving said icon operation changes with a lapse of time.
